(19) United States
(12) Patent Application Publication
(10) Pub. No.: US 2015/0225222 A1
(43) Pub. Date: Aug. 13, 2015

(54) Beverage Preservation, Chilling and Dispensing System

(71) Applicant: SUNBEAM PRODUCTS, INC., Boca Raton, FL (US)

(72) Inventors: Danene Jaffe, Weston, FL (US); Asoka Veeravagu, Boynton Beach, FL (US); Patricia Bassett, Boca Raton, FL (US)

(73) Assignee: SUNBEAM PRODUCTS, INC., Boca Raton, FL (US)

(21) Appl. No.: 14/625,315

(22) Filed: Feb. 18, 2015

Related U.S. Application Data
(63) Continuation of application No. 12/204,235, filed on Sep. 4, 2008, now abandoned.
(60) Provisional application No. 61/079,953, filed on Jul. 11, 2008.

(51) Int. Cl. B67D 1/08; B67D 1/04; B67D 1/00

(52) U.S. Cl. CPC B67D 1/0869; B67D 1/0004; B67D 1/0412

(57) ABSTRACT

A chamber for receipt and retention of a bottled beverage has a dispensing cartridge that interacts with a bottle to remove air therein to preserve the beverage under vacuum and to dispense the beverage under pressure. The vacuum and air pressure within the bottle is applied through a concentric pair of tubes introduced into the bottle as a part of the dispensing cartridge. A reversible pump is in fluid communication with the tubes. The chamber is maintained at a user-selected temperature using a thermoelectric cooling unit.

### CROSS-REFERENCE TO RELATED APPLICATIONS

This application is a continuation of U.S. non-provisional patent application Ser. No. 12/204,235 filed on Sep. 4, 2008, the contents of which are herein incorporated by reference in their entirety, which claims priority to U.S. Provisional Application No. 61/079,953 for Multi-Bottle Wine Preservation Chilling and Dispensing System, filed on Jul. 11, 2008, the contents of which are herein incorporated by reference in their entirety.

### FIELD

The disclosure relates in general to an apparatus for the preservation, chilling and dispensing of beverages. More particularly, the disclosure relates to such a system for the preservation, chilling and dispensing of distilled spirits and liquors, particularly such spirits or liquors that degrade over time when exposed to the atmosphere, such as wine.

### BACKGROUND

People throughout the world drink various distilled spirits and liquors; millions drink wine. Numerous types of wine are produced in many countries throughout the world. Most wine is distributed to consumers in bottles. Wine bottles are usually sealed with a cork to prevent exposure to the air and to preserve the wine. Consumers of wine may drink an entire bottle, a significant portion of a bottle or only one glass of wine or champagne at a time. Some consumers may drink a glass of wine a day while others may only drink one glass a week. When a bottle of wine is opened, the seal formed between the bottle and the cork is broken, air enters the bottle and the quality of the wine remaining in the bottle begins to degrade due to oxidation.

Wine begins to oxidize when it comes in contact with air and more specifically, with the oxygen present in the air. For a short period of time, oxygen and the process of oxidation benefit wine. With many types of wine, it is recommended to let the wine “breathe” before drinking. Breathing or exposing wine to ambient air for a short time allows a small amount of oxidation to induce the release of certain volatile compounds in the wine, which wine drinkers find to have a desirous effect on the wine's taste. Continued oxidation, however, eventually degrades every type of wine. To slow the degradation of the wine, a majority of wine is stored and preserved in bottles that are sealed with a cork or similar sealing device. However, uncorking or opening a wine

bottle generally initiates the beginning of the end of a wine's useful or tasteful life.

Red wines often degrade faster than white wines. Sweeter white wines tend to last longer, or degrade slower, than other white wines. Once the bottles are opened, most wines last less than a day even if the cork is properly replaced or the wine bottle is closed in a suitable period of time. In fact, the taste of some wines such as pinot noir begins to degrade within thirty minutes after opening the bottle. This is problematic because, as indicated above, often time people do not finish a bottle of wine or champagne on the day the bottle is opened. Accordingly, wine is often wasted because people only consume portions of a bottle and the remaining portions in the bottle lose their taste.

Attempts to reduce the oxidation and degradation of wine and thus to preserve wine have involved either limiting or eliminating the presence of oxygen to exposed wine surfaces. Since air includes approximately twenty-one percent oxygen, the attempts to preserve wine have involved either limiting or eliminating the presence of air to exposed wine surfaces. Simple procedures such as tightly replacing the cork are marginally effective at limiting the wine's degradation.

The problem with such simple procedures is practicality. Since wine is acidic and has a low pH, wine attracts oxygen from the open air. The extra hydrogen molecules of the wine seek electrons from the oxygen in the air. Longer exposures of wine to the open air increase the ionic balancing that takes place. Consequently, when a person forgets to immediately replace a cork after filling one or more glasses of wine, the degradation progresses and increases.

Numerous other solutions for wine preservation are also known, including systems that replace the air in the head space of the bottle with an inert gas (i.e., neutral or high-pressure systems). Similarly, individual bottle stoppers that allow for the removal of the air within the head space for such time as the stopper can maintain a vacuum within the bottle are also known (i.e., low-pressure systems). The purpose of each of these alternative solutions is to slow the degradation of and extend the life of the wine after the wine bottle is opened.

Known wine preservation and dispensing devices which use a neutral or over-pressure system typically rely on an inert gas such as nitrogen from a large gas storage cylinder or smaller portable containers. Several types of such nitrogen preservation systems are known. Some systems preserve only one wine bottle and others preserve a plurality of wine bottles. Examples of such systems are disclosed in U.S. Pat. Nos. 4,477,477; 4,595,121; 4,691,842; and 5,139,179.

U.S. Pat. No. 4,477,477 discloses an inert gas such as nitrogen dispensed into a wine bottle from a gas storage container such as a gas cylinder or gas cartridge. The inert gas travels through a tube and into the wine bottle. A sealing member is positioned around the tube and fits into the neck of the bottle to seal the bottle opening. The sealing member allows air to pass out of the bottle and the inert gas to be supplied to the bottle. While all of the air is generally not driven from the bottle, the inert gas forms a barrier between the remaining air and the wine. Once the inert gas fills the head space of the wine bottle and a significant amount of the air inside the bottle is displaced, the sealing member and tube are removed from the bottle and the cork is replaced. This manual process is repeated each time the user desires to preserve the wine in the bottle after the bottle has been opened.

Similarly, U.S. Pat. Nos. 4,595,121 and 4,691,842 disclose devices for dispensing and preserving degradable liquids such as wine. These devices include a cap or stopper having a gas supply tube and a wine dispensing tube, which is inserted into the opening of a wine bottle. The cap seals the opening of the bottle. A storage cylinder containing a non-degrading gas delivers the gas to the cap and into the wine bottle. The gas displaces the air inside the bottle. In U.S. Pat. No. 4,595,121, the cap or stopper disconnects from the gas supply tube and wine dispensing tube and remains in the wine bottle opening so that the user can store and preserve the wine for later use. In U.S. Pat. No. 4,691,842, the plug remains in the wine bottle until the bottle is empty.

Other known preservation systems employ a portable gas container, which can be transported by a user and attached to an opened wine bottle at remote locations. One such device is disclosed in U.S. Pat. No. 5,139,179. In this device, a stopper is inserted into an open wine bottle to seal the bottle opening from the air. A small gas cartridge containing an inert gas such as nitrogen or carbon dioxide is then attached to the top of the stopper. When the cartridge engages the stopper, the cartridge releases the inert gas into the wine bottle. The inert gas displaces the air inside the bottle and promotes the preservation of the wine as well as the dispensing of the wine from the bottle. The gas cartridge is then disconnected from the stopper. The stopper remains in the wine bottle opening for storage and future use if desired. Other known wine preservation devices use a small portable gas canister or gas cylinder bottle to supply an inert gas to a wine bottle.

Despite the advantages provided by some of the known systems, the need exists for a system that is capable of maintaining the preservation condition within the bottle without any mandatory action of the user. Further, the need exists for such a system that is suited for aiding in both the maintenance and preservation of the wine or spirits by maintaining the bottle at an appropriate reduced temperature based on the wine or spirit being preserved. Such needed system should preferably also provide a methodology for further preserving the wine or spirit without the need for cartridges or canisters that require repeated re-filling and or which require some remote source for an inert gas.

These and other features, aspects and advantages of the present disclosure will become better understood with reference to the following descriptions and appended claims. The accompanying drawings, which are incorporated in and constitute a part of this specification, illustrate at least one embodiment and, together with the descriptions, serve to explain the principles of the disclosure.

### SUMMARY OF THE DISCLOSURE

A beverage preservation, chilling and dispensing system is provided, which has at least one chilling chamber suited to maintain and dispense a distilled spirit, liquor or a wine. The system may comprise an outer housing for housing the at least one chilling chamber. The front wall of both the outer housing and each of the at least one chilling chambers may include an opening for the provision of a thermally insulated hinged door for access to the interior of the associated chilling chamber. Similarly, above each hinged door may be provided an opening for the insertion of a dispensing cartridge.

On the interior of the outer housing above each chilling chamber may be provided a plurality of supporting rails on which a dispensing cartridge may be introduced into a respective one of the at least one chilling chamber. In addition to supporting the bottle within the chamber in a hanging position so as to accommodate bottles of varying heights, the dispensing cartridge may additionally comprise cooperative bottle securing, sealing and dispensing mechanisms. The bottle securing mechanism may include a stopper element, which may cooperatively work with a piston and a lower portion of the cartridge to compress the bottle sealing mechanism, a gasket element, for enhancing the fit between the interior surface of the bottle's neck and the exterior surface of the gasket. In order to engage the compression of the gasket element, a locking handle on the cartridge may be rotated from a first position in which the bottle is freely introduced or removed from the dispensing cartridge to a second position in which the bottle is secured to the cartridge prior to introduction into the at least one chilling chamber along the plurality of supporting rails.

Passing through the center of the piston, the gasket and stopper element may be provided a pair of concentric passages or airspaces formed by a tube within an opening. The outer concentric passage may be in fluid communication with an air passageway passing through the dispensing cartridge to a connecting port on the back thereof for interaction with a reversible pump which may be used to generate a vacuum within the bottle and/or to pressurize the bottle for dispensing. The inner passage may be the wine dispensing passage, which is in fluid communication with a dispensing head located on the front of the dispensing cartridge. The inner passage allows the dispensed liquid to be driven through it by the heightened pressure within the bottle and to thus be dispensed on demand.

Each chilling chamber may be provided with a thermoelectric cooling unit for regulating the temperature within the associated chilling chamber. Each cooling unit may include a pair of fans. One fan may be associated with a heat absorbing material for withdrawing heat from the air in the chilling chamber. The other fan may be associated with a heat sink for passively radiating the excess heat to the ambient air. The thermoelectric cooling units are operated to manage the temperature within their individual chilling chamber based or a user input temperature setting for the respective chilling chamber.

Additional advantages of the disclosure are set forth in, or will be apparent to those of ordinary skill in the art from, the detailed description as follows. It should also be appreciated that modifications and variations to the specifically illustrated and discussed features hereof may be practiced in various embodiments and uses of this disclosure without departing from the spirit and scope thereof. Such variations may include, but are not limited to, substitutions of equivalent means and features for those shown or discussed, and the functional or positional reversal of various parts, features or the like.

Still further, it is to be understood that different embodiments of this disclosure may include various combinations or configurations of presently disclosed features, elements, or their equivalents (including combinations of features or configurations not expressly shown in the figures or stated in the detailed description).

### DRAWINGS

A full and enabling disclosure, directed to one of ordinary skill in the art, is set forth in this specification, which makes reference to the appended figures, in which:

FIG. 1 is a front right perspective view of one exemplary embodiment of the beverage preservation, chilling and dispensing system of the present disclosure;

FIG. 2 is a front view of the embodiment of FIG. 1 having three separate chill chambers;

FIG. 3 is a right view of the embodiment of FIG. 1;

FIG. 4 is a top view of the embodiment of FIG. 1;

FIG. 5 is a cross-section view of the system of FIG. 1 taken along line A-A of FIGS. 2 and 4;

FIG. 6 is a front right perspective view of an isolated thermoelectric unit for use in association with each chill chamber;

FIG. 7A is an isolated view of a dispensing cartridge in association with a bottle showing the cartridge and bottle in an unlocked configuration;

FIG. 7B is an isolated view of a dispensing cartridge absent the dispensing head and in association with a bottle showing the cartridge and bottle in an unlocked configuration;

FIG. 7C is an isolated view of the piston in association with a bottle showing the longitudinal slot in the piston for interaction with the locking handle and the additional space within the bottle's neck for receipt of a lower portion of the dispensing cartridge;

FIG. 7D is an isolated view of the piston and locking handle in association with a bottle showing the handle in an unlocked configuration;

FIG. 8A is an isolated view of a dispensing cartridge in association with a bottle showing the cartridge and bottle in a locked configuration;

FIG. 8B is an isolated view of a dispensing cartridge absent the dispensing head and in association with a bottle showing the cartridge and bottle in a locked configuration;

FIG. 8C is an isolated view of the piston and locking handle in association with a bottle showing the handle in a locked configuration;

FIG. 9A is a cross-sectional view taken along line B-B of FIGS. 3-5 and 8 showing an isolated view of the piston, dispensing tube and the locking handle in a locked configuration;

FIG. 9B is a close-up partial cross-section view of the dispensing cartridge and bottle taken along line A-A of FIGS. 2 and 4 showing the fluid flow path for the removal and introduction of air from and into the bottle, as well as the fluid flow path for dispensing a beverage from the bottle, wherein the locking handle is in an unlocked position;

FIG. 9C is a close-up partial cross-section view of the dispensing cartridge and bottle taken along line A-A of FIGS. 2 and 4 showing the completion of the fluid flow path for evacuating or pressurizing the bottle wherein the locking handle is in a locked configuration, as well as showing the dispensing carttidge's interrelationship with the controls for evacuating or pressurizing the bottle, dispensing liquid from the bottle and for releasing the dispensing cartridge from the system;

FIG. 10 is a partial cross-section view of a dispensing cartridge showing a door-detection assembly for use with each chill chamber; and

FIG. 11 is a close-up cross-section view of the dispensing head of the dispensing cartridge showing a partial view of the fluid flow path for the dispensed beverage and the check valve for terminating such dispensing.

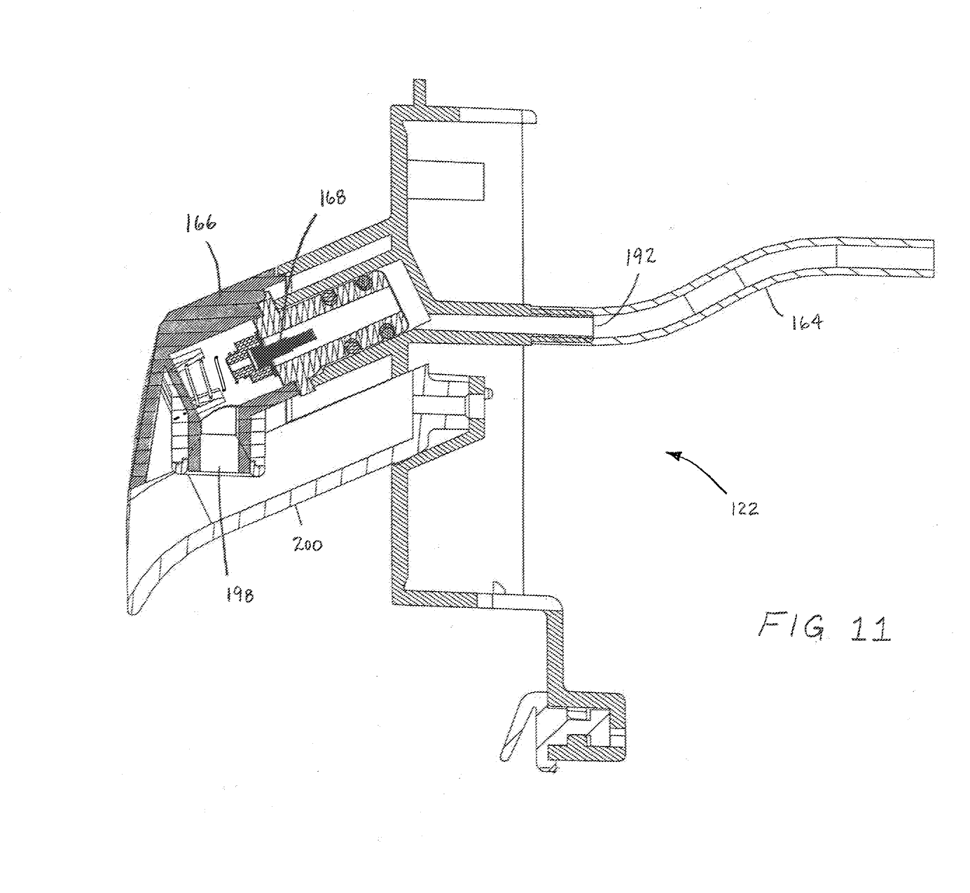

Repeated use of reference characters throughout the present specification and appended drawings is intended to represent the same or analogous features or elements of the present disclosure.

### DETAILED DESCRIPTION

Reference will now be made in detail to the presently preferred embodiment or embodiments of the disclosure, examples of which are fully represented in the accompanying drawings. Such examples are provided by way of an explanation of the disclosure not a limitation thereof. Still further, variations in characteristics may be practiced, to satisfy particular desired user criteria. Thus, it is intended that the present disclosure cover such modifications and variations as coming within the scope of the present features and their equivalents.

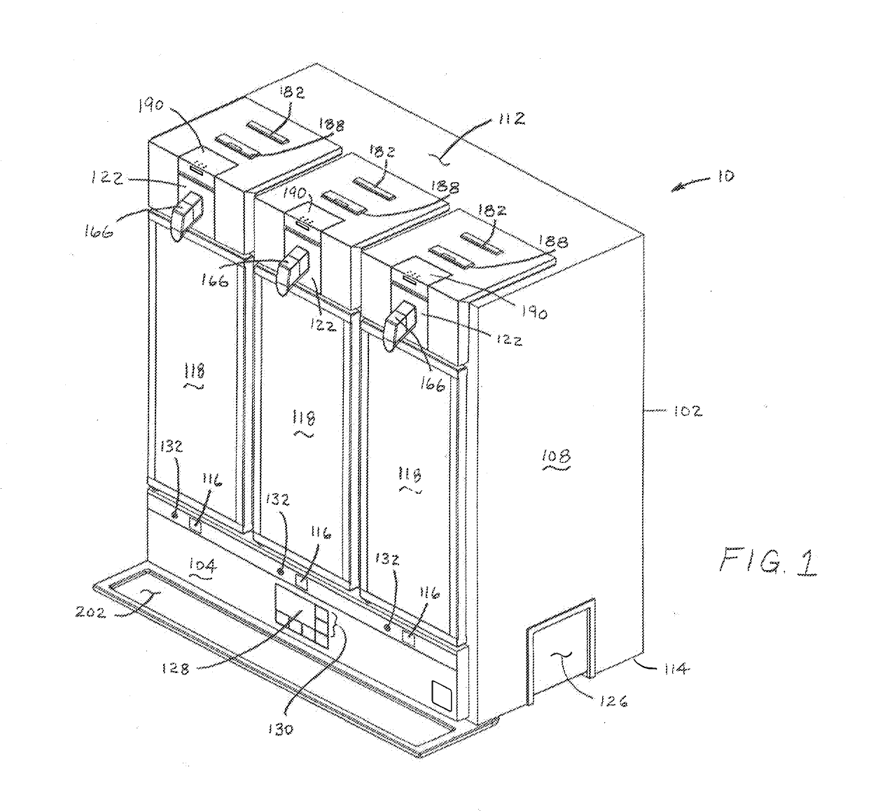

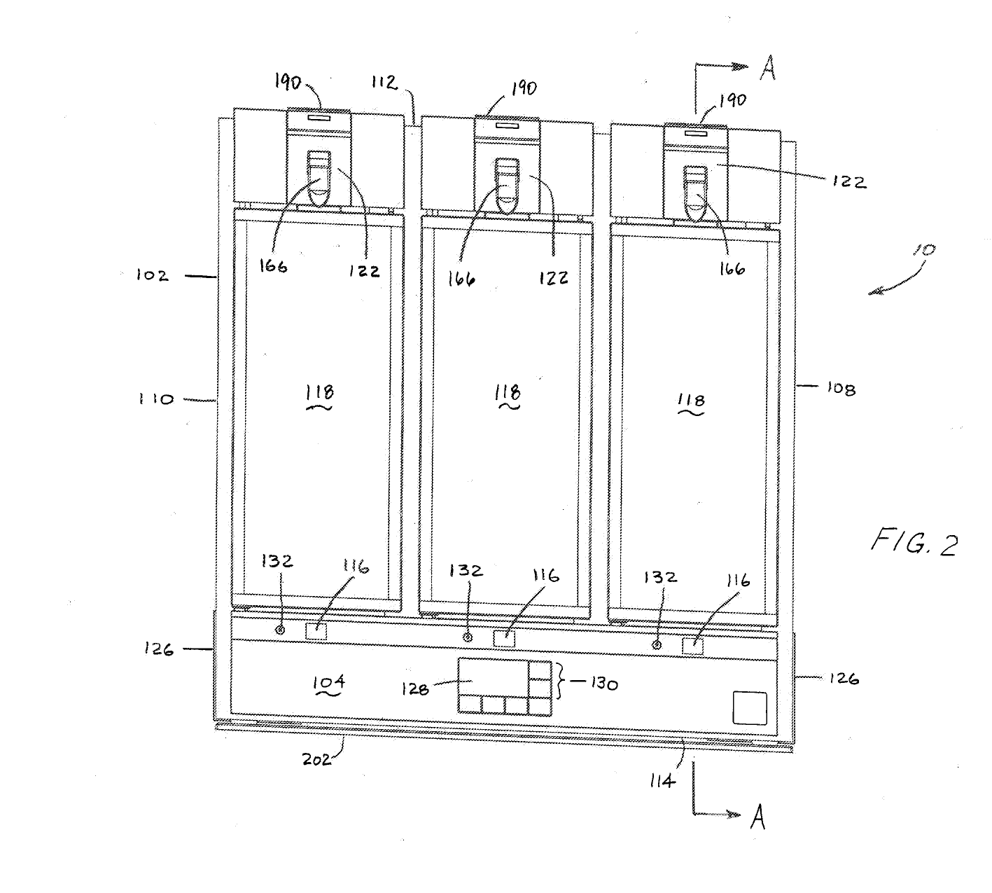

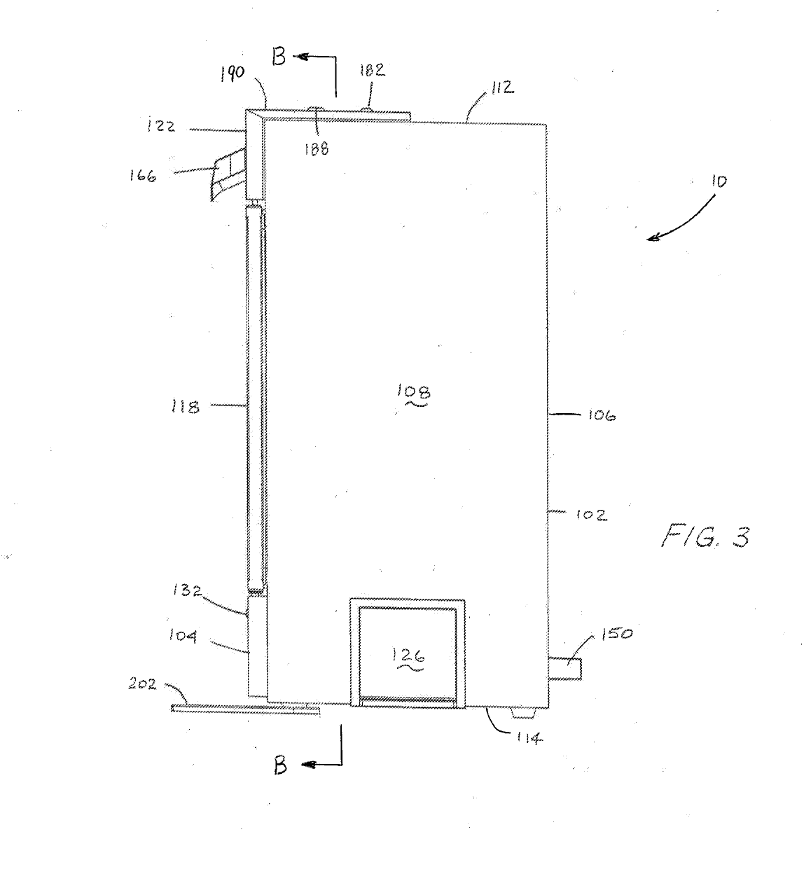

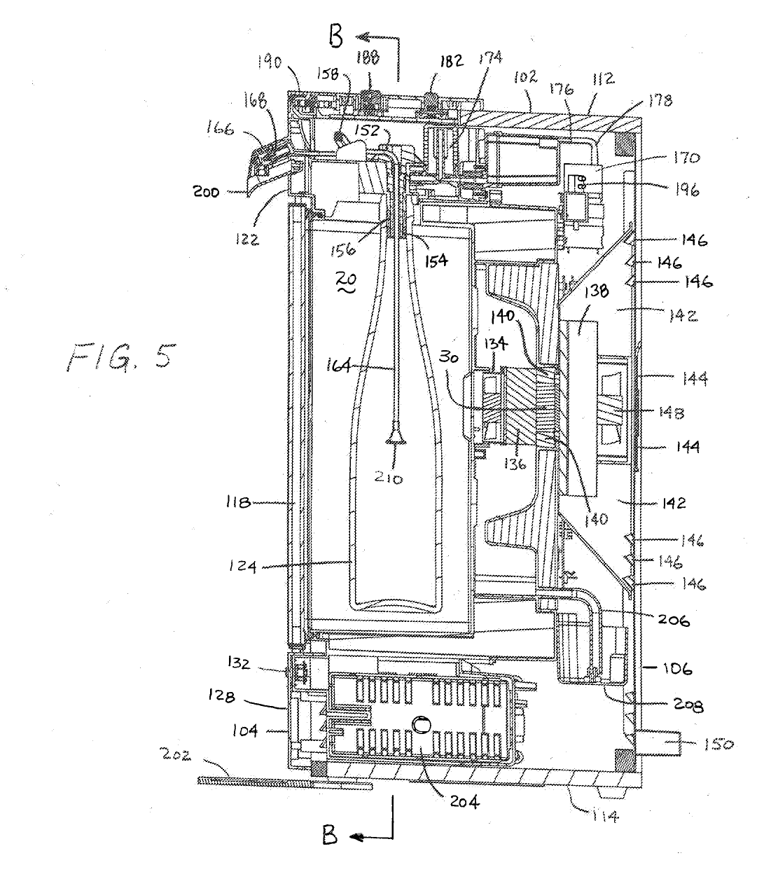

As disclosed above the present invention is particularly concerned with a preservation, chilling and dispensing system 10 having at least one chill chamber 20 (see FIG. 5) suited to maintain and dispense a distilled spirit, liquor or wine. As best seen in FIGS. 1-3 and 5, the system 10 includes an outer housing 102 having front, back, right, and left upstanding walls, 104, 106, 108 and 110, respectively. The outer housing 102 further includes a top 112 and bottom 114 wall, which together with the upstanding walls 104, 106, 108 and 110 form an enclosure. The front wall 104 includes at least one opening therein for positioning of a hinged door 118 associated with the at least one chill chamber 20. Similarly, above each hinged door opening in the outer housing front wall 104 is an opening for the insertion of a dispensing cartridge 122, such dispensing cartridge 122 being in direct physical contact and fluid communication with a bottled liquid 124 (FIG. 5) to be placed within the system 10. Further, each of the right and left upstanding walls 108 and 110 are provided with a handle 126 sufficient to support the fully loaded weight of the system 10 during a reorientation or repositioning by a user thereof.

On the front wall 104 of the outer housing 10 is located a user interface 128 for individual selection of an individual one of the at least one chill chamber 20. As part of the user interface 128, a user may individually set the temperature of each chill chamber 20 through the use of an up/down temperature adjustment feature 130. Alternatively, the user interface 128 may allow a user to set the temperature of each available chill chamber 20 based on the type of liquid stored therein. By way of example, but not limitation, the user interface 128 may partially include a look-up table based on a type of wine to be stored. Therefore, by selecting for example, a Chablis, Pinot Noir, Merlot, or Zinfandel, the user interface 128 may be triggered to set the temperature of the selected chill chamber 20 to the generally accepted optimum storage temperature for the wine type indicated. In addition to the user interface 128, each chill chamber 20 may be individually provided with a chamber temperature indicator 116 and a chamber activation/deactivation switch 132 on the front wall 104 of the outer housing 102. The chamber temperature indicator 116 informs the user that the bottled liquid 124 within the chamber 20 is within a predefined range of the user set temperature. Additionally, each chill chamber 20 may be provided with an internal light for illuminating the chamber as dictated by a user.

As best seen in FIG. 5, the system 10 includes at least one chill chamber 20 recessed within the outer housing 102. Similar to the construction of the outer housing 102, each chill chamber 20 includes right, left and rear upstanding walls, as well as top and bottom walls for encompassing an enclosure. The front of the chill chamber may be flush with the front wall 104 of the outer housing 102. The front of the chill chamber preferably coincides with the opening in front wall 104 for insertion of the chill chamber 20 and includes a thermally insulated hinged door 118 which is affixed in said opening so as to complete the chill chamber's enclosure 20. Between the door and the chill chamber 20 may be provided a sealing gasket (not shown) to ensure-a complete closure of the door 118 and to enhance the thermal efficiency of the chill chamber 20.

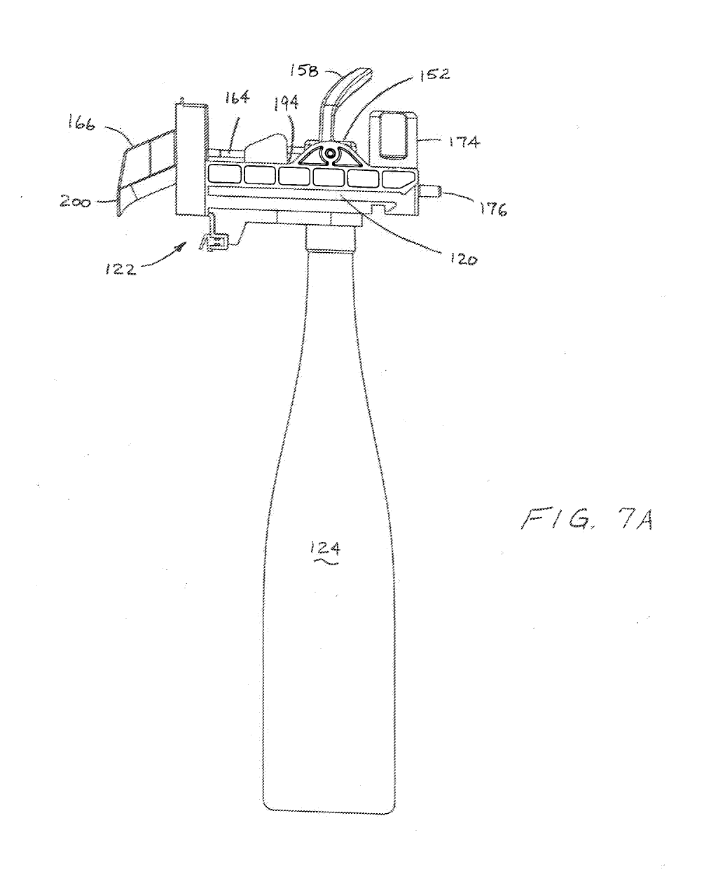

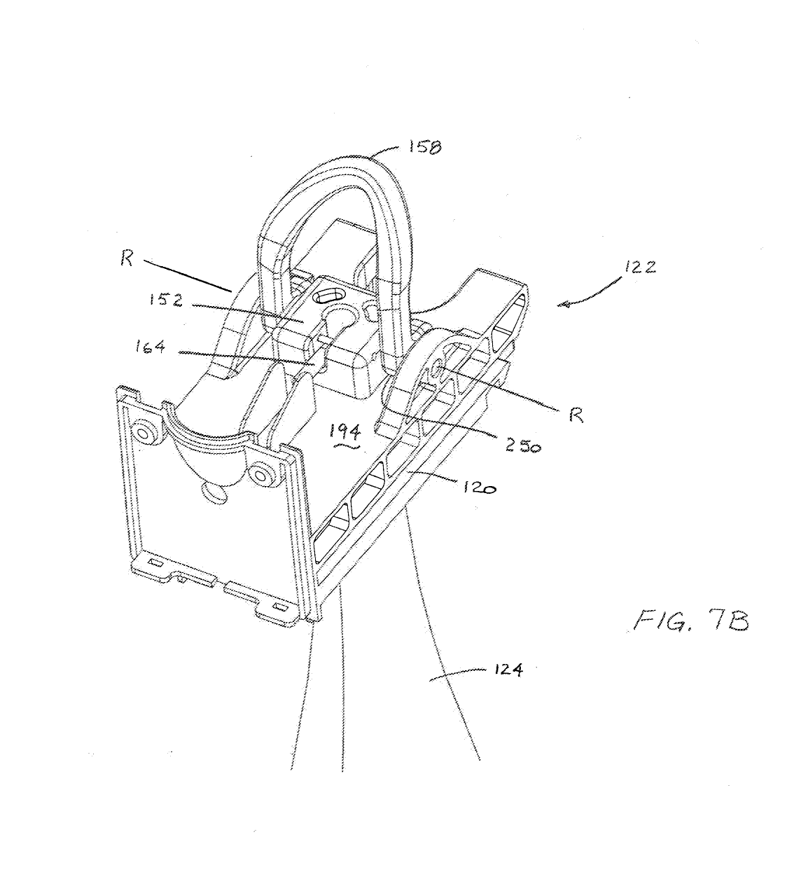

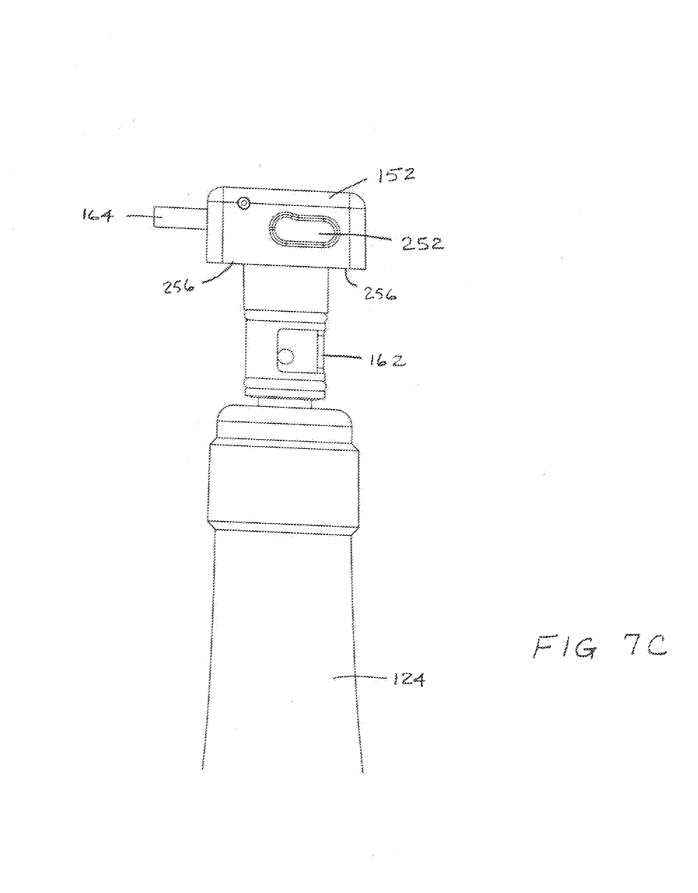

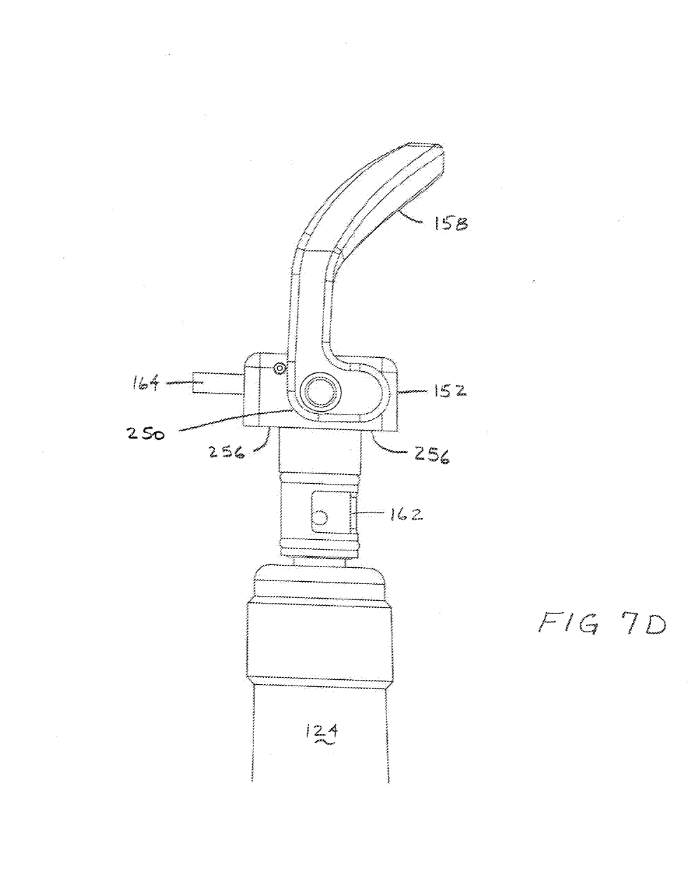

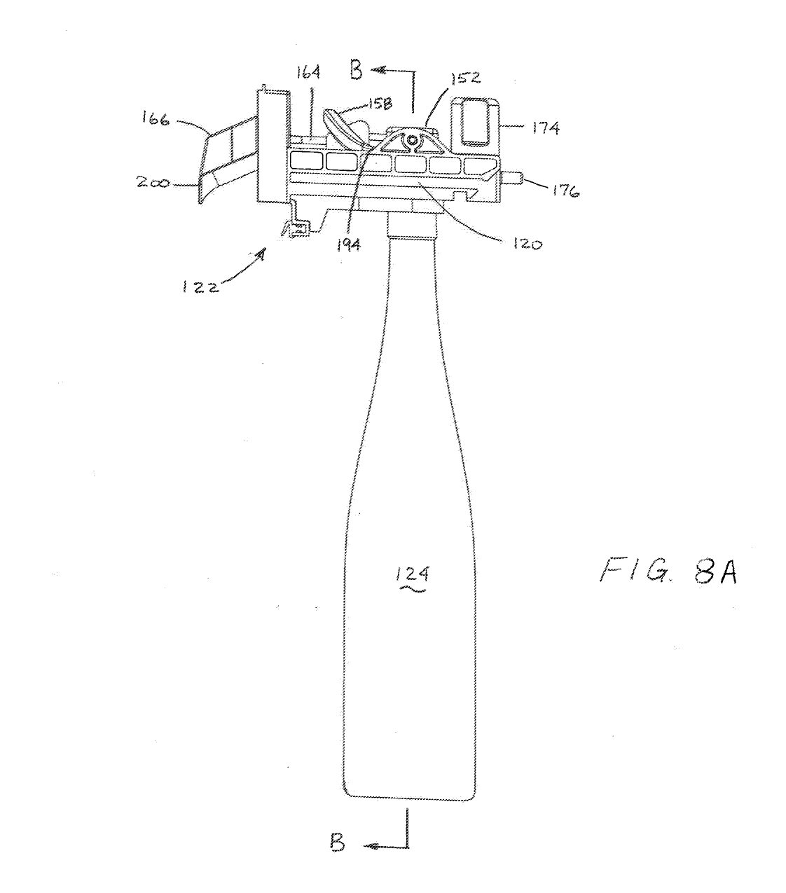

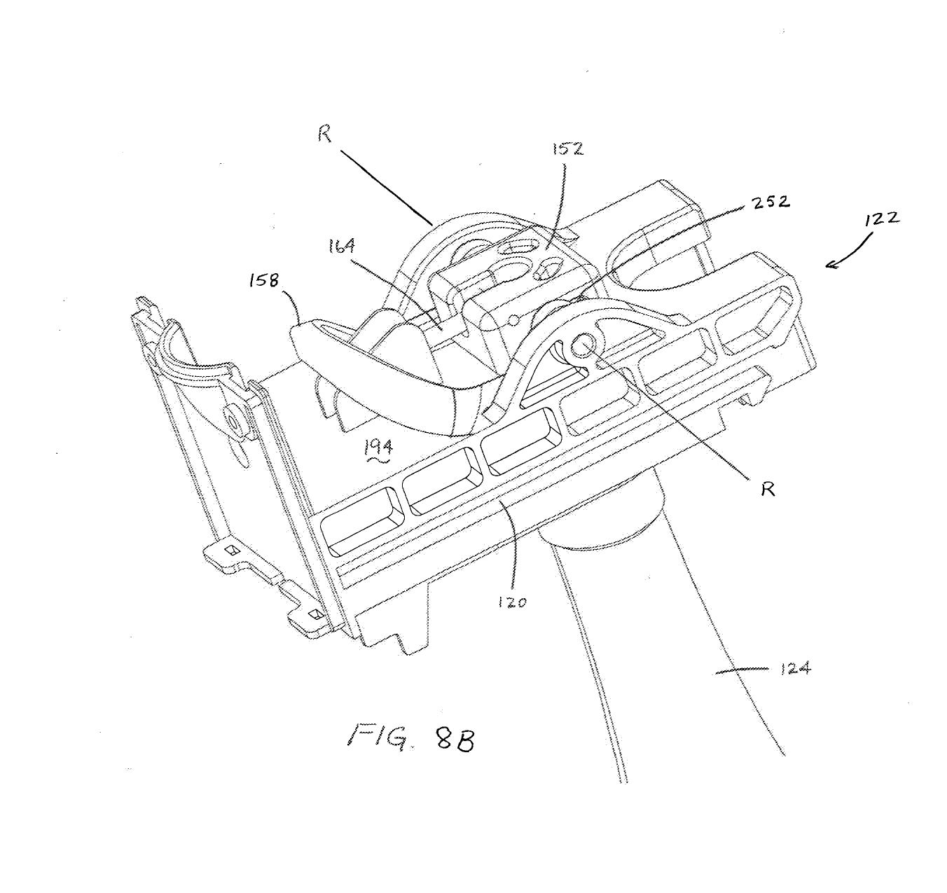

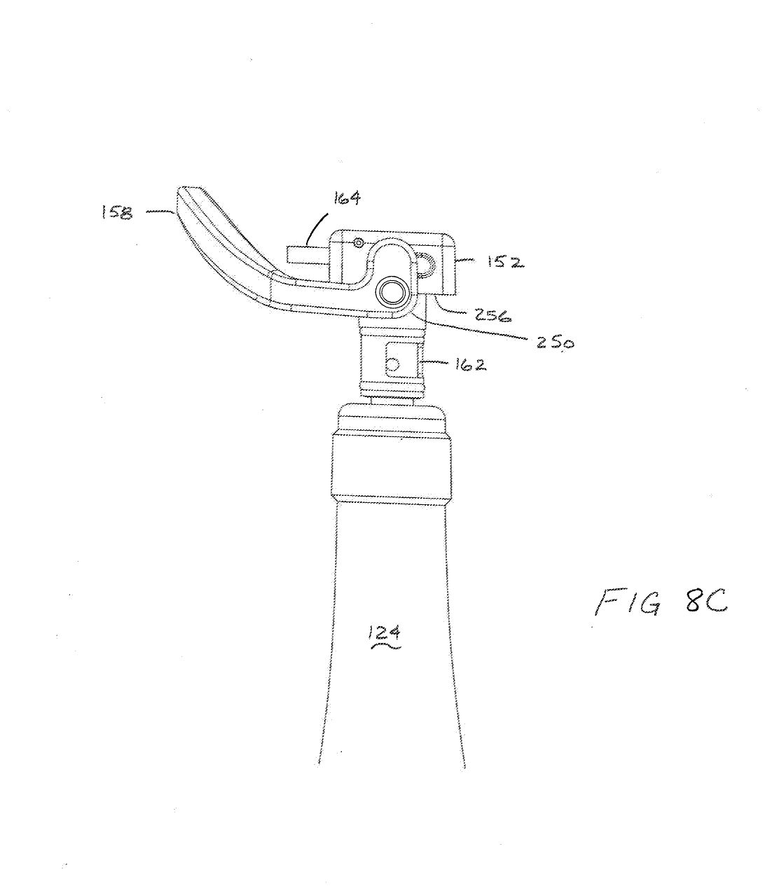

As with the outer housing opening for the dispensing cartridge 122, a corresponding opening (not shown) is provided in the top wall of the chill chamber 20 for receipt of the dispensing cartridge 122 and an associated container, such as, but not limited to a bottle 124. As such, the opening in the top of the chill chamber 20 must extend to the forward periphery of the top of the chill chamber 20. The dispensing cartridge 122 completes the chill chamber enclosure 20 in one embodiment through an insertion on a slide-rail system 120 (FIGS. 7A, 7B, 8A and 8B) mounted on the side of the cartridge 122 and within the outer housing 102. Such a mounting system provides both the physical support for the cartridge/bottle combination, as well as appropriate alignment of the cartridge 122 to complete the fluidic connection required for proper operation of the system 10 once inserted into the chill chamber 20.

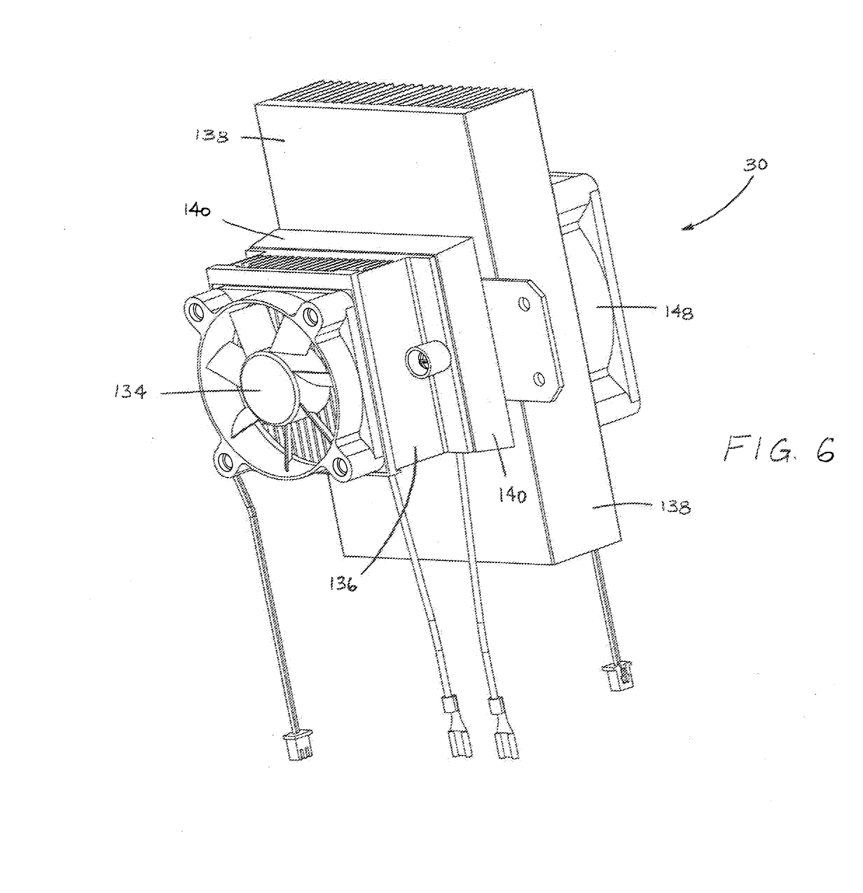

As seen in FIGS. 5 and 6, each chill chamber 20 includes an individual thermoelectric unit 30 suited for regulation of the temperature within the chill chamber 20. Each unit 30 comprises a cool side fan 134 for movement of the air within the chill chamber 20. Additionally, the cool side fan 134 passes the air over a cooling material 136 which cools the air within the chill chamber 20. In so doing, the thermoelectric unit 30 is capable of regulating the temperature within the chill chamber 20 within a range of temperatures as determined by a user input as discussed above.

In order to generate the cooling effect of material 136, an electrically generated temperature differential is created between the cooling material 136 and a heat sink 138 which is thermally isolated from the cooling material 136 by an insulator layer 140. In a well-known manner, the application of electrical energy across two different semi-conductive materials generates a temperature differential across the materials. In the thermoelectric units 30 in use in the system 10, the electrical energy flow is arranged such that the temperature differential generated results in a lower temperature on the chill chamber side of the thermoelectric unit 30, which allows for regulation of the temperature within the chill chamber 20. Such arrangement also generates an elevated temperature at heat sink 138 which must be managed. In order to rid the system 10 of the excess heat, heat sink 138 resides within a large air flow passage 142 containing inlet and exhaust openings 144 and 146 in the back wall 106 of the outer housing 102. It is through the exhaust openings 146, that the heat sink 138 radiates the generated heat from within the system 10. To aid in such heat transmission to the ambient, the heat sink 138 is associated with a hot side fan 148 sized sufficiently to draw air into the air flow passage 142 through inlet openings 144 across the heat sink 138 and out the exhaust openings 146. To ensure sufficient air flow through the air flow passage 142, the outer housing is provided with at least one standoff 150 which maintains the back wall 106 of the outer housing 102 away from any surface near which it may be placed. In operation, condensation will form on the cool side of the thermoelectric unit 30. Such condensation requires collection for later dissipation back into the atmosphere. To provide for such a capability, as seen in FIG. 5, each thermoelectric unit 30 is provided with a condensation drain tube 206 and a collector tray 208 which allows for collection of the condensation in a single location for evaporation back into the atmosphere.

As mentioned above and best seen in FIGS. 7A, 7B, 8A, 8B and 9A-9C, the bottled beverage 124 is supported within the chill chamber 20 by its dispensing cartridge 122. Each cartridge is provided with an elongated plug or piston 152 shaped to fit within a contoured passage running through the cartridge 122. A first end of the piston 152 is maintained above the upper surface 194 of the dispensing cartridge 122. The opposing second end of the piston 152 extends beyond the bottom of the cartridge 122 for insertion into a bottle 124 and is associated with a stopper element 154 which is wider than the contoured passage through which the piston 152 passes, thus preventing the inadvertent removal of the piston 152 from the contoured passage. The stopper element 154 is physically secured to the piston 152, such as for example by way of threaded connection or by being pinned together or both. Secured between the bottom of the cartridge 122 and the top of the stopper element 154 is a gasket element 156.

of solenoids 196 may be used to manage the operational connections between the various chambers 20 and the pump 170.

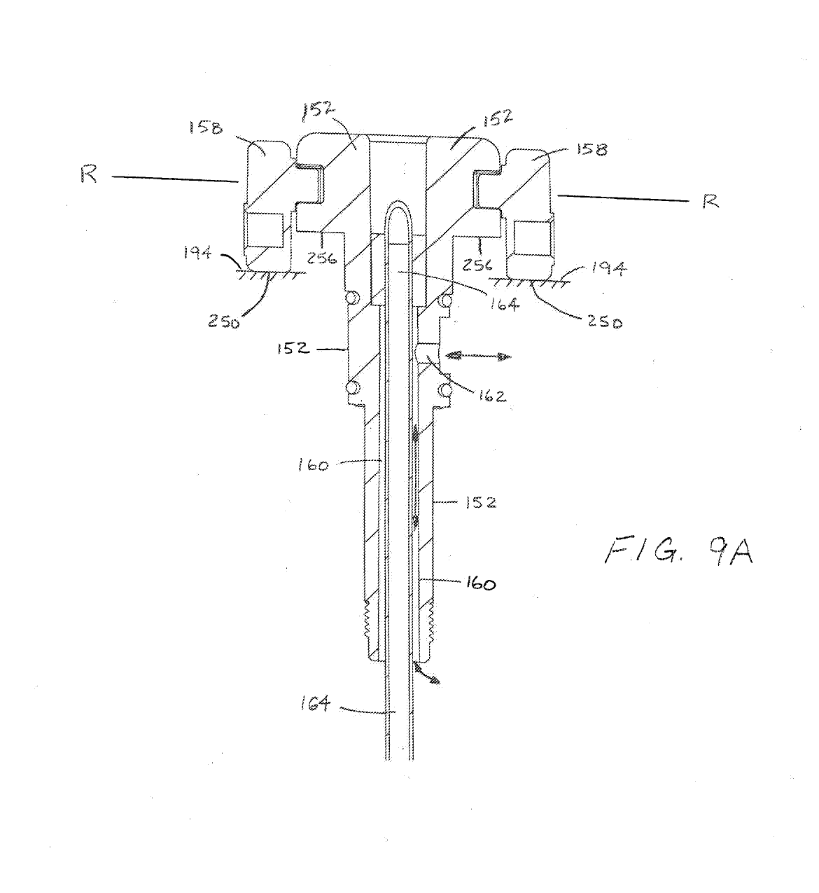

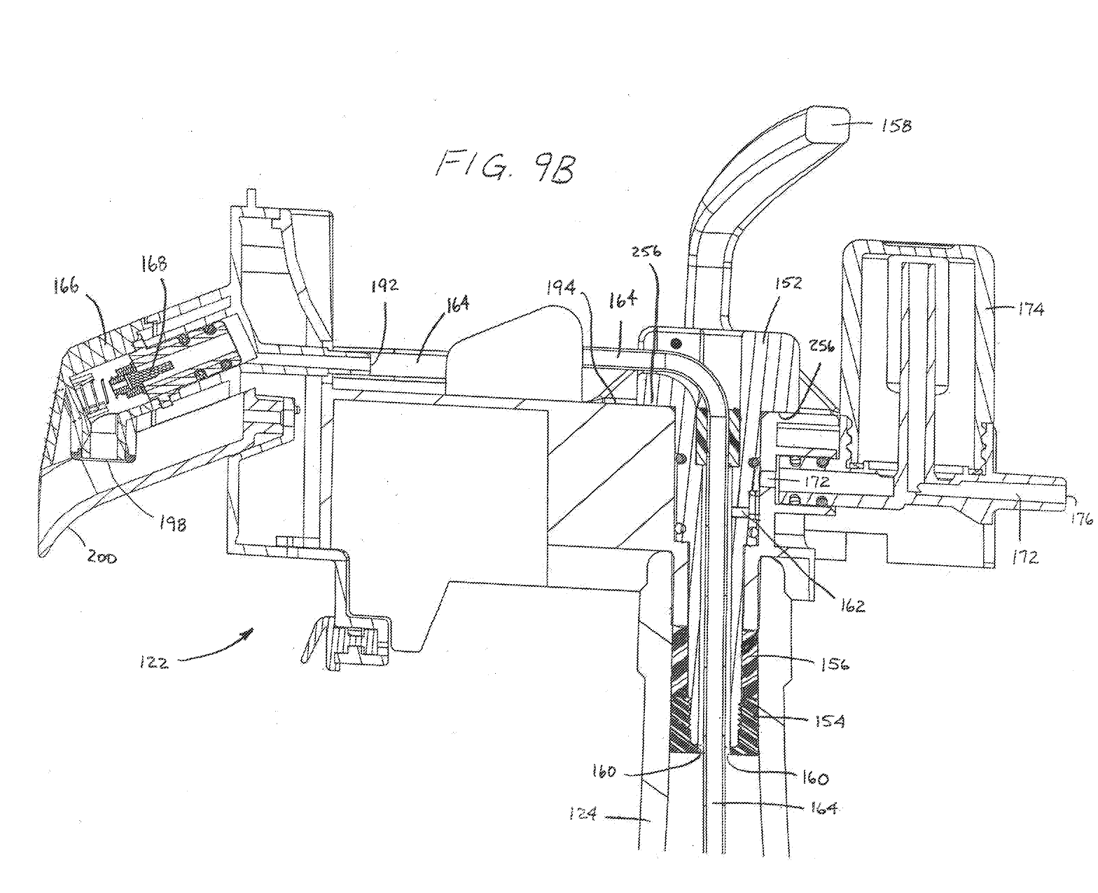

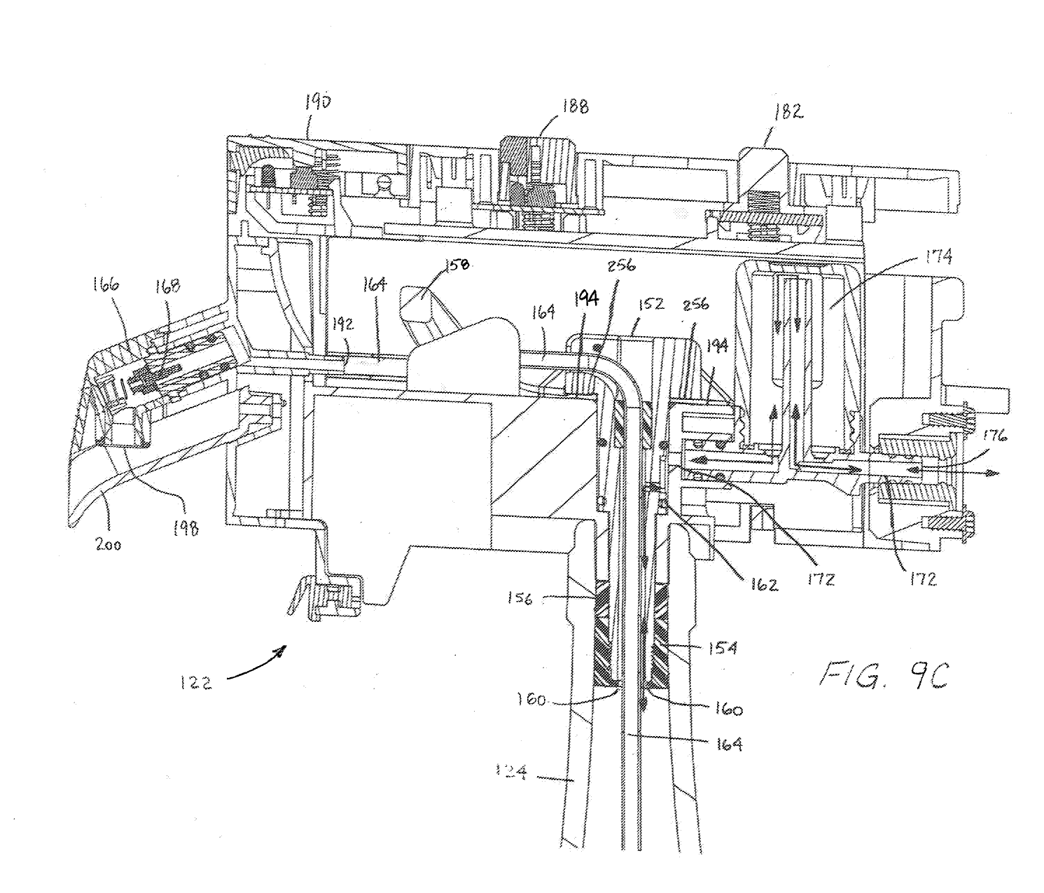

As indicated by arrows in FIGS. 9A-9C, such arrows indicating the direction of and passages utilized for fluid flow during evacuation and pressurization of the bottle, where the locking handle 158 is in an unlocked condition (FIG. 9B) primary vacuum/pressurization conduit 162 terminates at a wall of the central passage 160 and is prevented from fluid communication with a secondary vacuum/pressurization conduit 172 and ultimately reversible pump 170. As seen in FIG. 9C, however, where the locking handle 158 is in a locked configuration the linear upward movement of piston 152 aligns primary vacuum/pressurization conduit 162 with secondary vacuum/pressurization conduit 172 and reversible pump 170, which allows the system to evacuate or pressurize the bottle 124. Within the fluid flow path between secondary vacuum/pressurization conduit 172 and reversible pump 170 is preferably located at least one liquid collection housing 174 for trapping any liquid inadvertently drawn through primary and secondary vacuum/pressurization conduits 162 and 172. Trapping of such liquid prevents aspiration of the liquid into the pressure sensor (not shown) or the reversible pump 170. At the end of the secondary conduit 172 opposite the end at which it interfaces with the central passage 160, there exists an inlet/outlet junction 176. Junction 176 connects the secondary conduit 172 with primary vacuum/pressurization hose 178 whose opposing end connects to the reversible pump 170. As noted above, where a plurality of chill chambers 20 is supported by a single pump 170, a bank of solenoids 196 may precede the pump 170 in the above-described fluid flow path. It is only through the linear upward movement of the piston 152 and the resultant initiation of fluid communication between primary conduit 162 and secondary conduit 172 that the pump may be connected to the internal atmosphere of the bottle 124 for generation of the sub- or super-atmospheric pressure conditions as demanded by a user.

As described above and in operation, after insertion of the concentric dispensing tube 164, the piston 152, the stopper element 154, the interleaved gasket element 156 into the open end of a bottle 124 and after levering the locking handle 158 into a locked Such change in position is the result of the linear upward movement of the piston 152 within the contoured passage of dispensing cartridge 122.

In securing the bottle 124 to the dispensing cartridge 122 by rotation of the locking handle 158 to its locked position, the upward linear motion of the piston 152 generates an identical upward linear motion of stopper element 154 because it is secured to the lower end of piston 152. Such upward linear movement of stopper element 154 axially compresses annular gasket element 156 between the stopper element 154 and the bottom of the contoured passage of the cartridge 122 as best seen in FIG. 9C. Preferably gasket element 156 is a rubber-like compound; its compression forcing it to expand radially. Such expansion serves to generate a complete airtight seal between the gasket element 156 and the interior of the neck of the bottle 124. Further, the frictional force between the gasket element 156 and the bottle 124 is sufficient to allow for the dispensing cartridge 122 to maintain even a full bottle 124 in a hanging configuration. Use of such a method of securing the bottle 124 is particularly useful for allowing the chill chamber 20 to accommodate bottles 124 of varying sizes and heights.

As best shown in FIG. 9A, passing through the piston 152, the stopper element 154, and the gasket element 156 is a central passage 160. As will be discussed in more detail below, this central passage 160 cooperates with a primary vacuum/pressurization conduit 162 to allow for the creation of a sub-atmospheric pressure condition within the bottle 124 when preservation of the bottle's contents are intended or to allow for the creation of a super-atmospheric pressure condition within the bottle 124 when dispensing of the liquid therein is desired. Within the central passage 160 is placed a concentric dispensing tube 164 which at a first end extends into the bottle 124 and which at a second end is associated with the dispensing head 166 of the dispensing cartridge 122 and is sealed by a spring-biased check valve 168.

The system 10 is provided with at least one reversible pump 170 (FIG. 5) for generation of the sub-atmospheric and super-atmospheric pressure conditions within said bottle 124. Where multiple chill chambers 20 are serviced by a single pump 170 a bank of solenoids 196 may be used to manage the operational connections between the various chambers 20 and the pump 170.

As indicated by arrows in FIGS. 9A-9C, such arrows indicating the direction of and passages utilized for fluid flow during evacuation and pressurization of the bottle, where the locking handle 158 is in an unlocked condition (FIG. 9B) primary vacuum/pressurization conduit 162 terminates at a wall of the central passage 160 and is prevented from fluid communication with a secondary vacuum/pressurization conduit 172 and ultimately reversible pump 170. As seen in FIG. 9C, however, where the locking handle 158 is in a locked configuration the linear upward movement of piston 152 aligns primary vacuum/pressurization conduit 162 with secondary vacuum/pressurization conduit 172 and reversible pump 170, which allows the system to evacuate or pressurize the bottle 124. Within the fluid flow path between secondary vacuum/pressurization conduit 172 and reversible pump 170 is preferably located at least one liquid collection housing 174 for trapping any liquid inadvertently drawn through primary and secondary vacuum/pressurization conduits 162 and 172. Trapping of such liquid prevents aspiration of the liquid into the pressure sensor (not shown) or the reversible pump 170. At the end of the secondary conduit 172 opposite the end at which it interfaces with the central passage 160, there exists an inlet/outlet junction 176. Junction 176 connects the secondary conduit 172 with primary vacuum/pressurization hose 178 whose opposing end connects to the reversible pump 170. As noted above, where a plurality of chill chambers 20 is supported by a single pump 170, a bank of solenoids 196 may precede the pump 170 in the above-described fluid flow path. It is only through the linear upward movement of the piston 152 and the resultant initiation of fluid communication between primary conduit 162 and secondary conduit 172 that the pump may be connected to the internal atmosphere of the bottle 124 for generation of the sub- or super-atmospheric pressure conditions as demanded by a user.

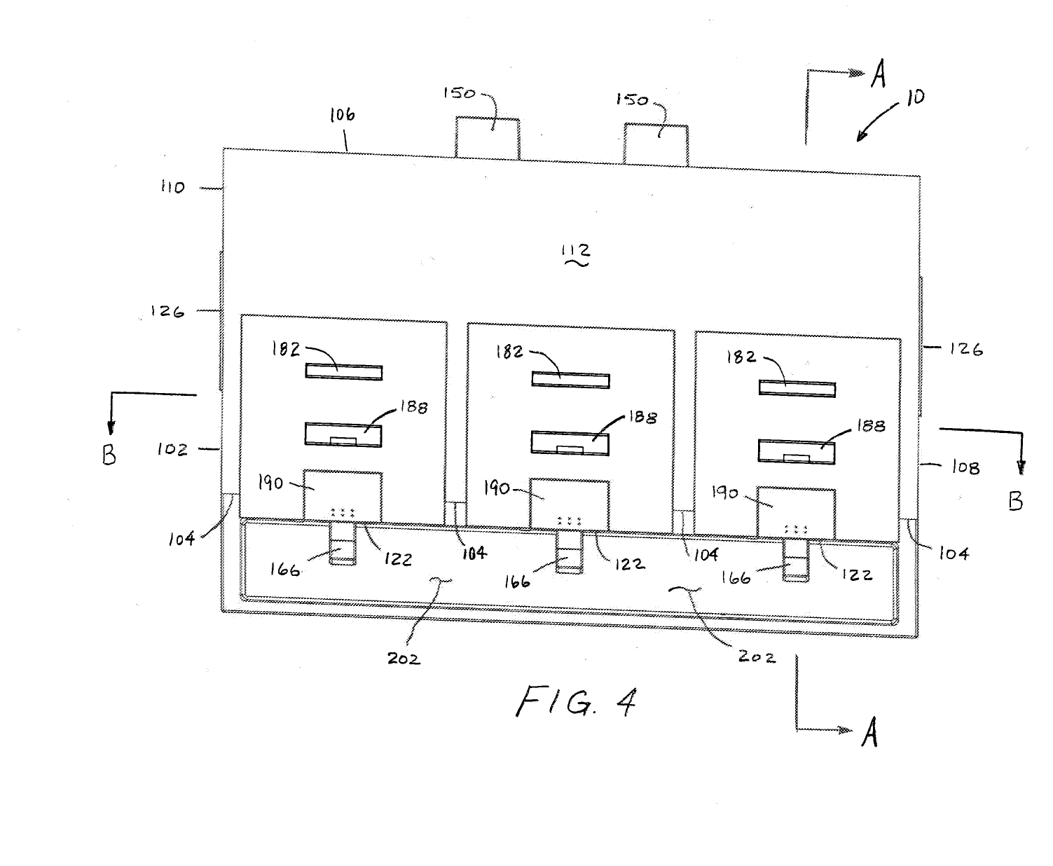

As described above and in operation, after insertion of the concentric dispensing tube 164, the piston 152, the stopper element 154, the interleaved gasket element 156 into the open end of a bottle 124 and after levering the locking handle 158 into a locked configuration, the bottle 124 will be secured to the dispensing cartridge 122 as described above. Further, the primary and secondary vacuum/pressurization conduits 162 and 172 will have been brought into fluid communication for vacuum/pressurization operations within the bottle 124. The cartridge/bottle combination is inserted into a secured position within the chill chamber 20 and the outer housing 102 on a slide-rail system 120. Once securely inserted the cartridge/bottle combination can only be removed after activation of a release button 182 (FIGS. 1, 3-5 and 9C) located on an upper surface of outer housing 102. Proper positioning of the cartridge/bottle combination ensures secured air-tight fluid communication between the inlet/outlet junction 176 of the cartridge 122 and the primary vacuum/pressurization hose 178 connected to the pressure sensor (not shown) and the reversible pump 170.

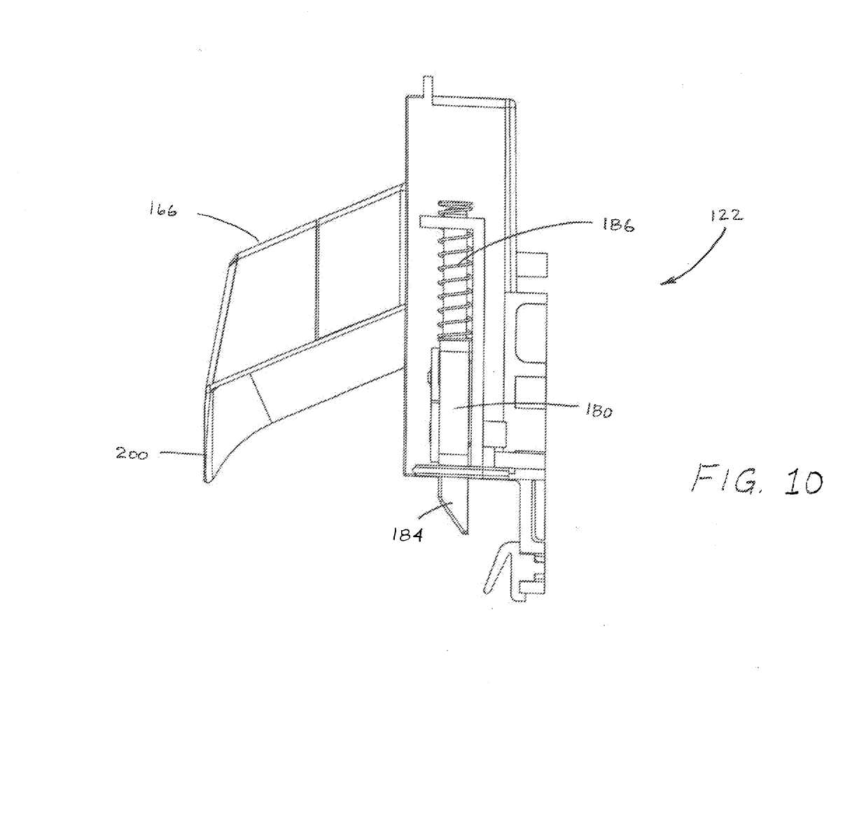

To allow for operation of the chill chamber 20 to begin the user must close the thermally insulated hinged door 118 of the chill chamber 20. As seen in FIG. 10, located within the leading edge of cartridge 122 is a spring-biased door detection mechanism 180 for detecting the secured or unsecured condition of the door 118. During closure of the door 118, an inner surface of the door engages an angled first end 184 of the detection mechanism 180 forcing the mechanism 180 upward. Such movement forces a compression of spring 186 and communicates the status of the door 118 as being closed to the chill chamber's power supply 204. Should a user fail to fully close the door 118 after a predefined period of time, the chill chamber's individual power supply 204 would be terminated to both conserve electrical power consumption by the chamber 20 and to reduce or eliminate the creation of condensation generated as a result of the continuous operation of the thermoelectric unit 30 which would be trying to cool the interior of an open chamber 20.

The system 10 is provided with a plurality of user operations buttons, each associated with a printed circuit board for activation of the appropriate components within the system for achieving the selected user-indicated result. For instance, a preservation button 188 is provided. When pressed by a user, the preservation button 188 triggers the reversible vacuum pump 170 to initiate a vacuum operation on the bottle 124 in the chill chamber 20 associated with that preservation button 188. The vacuum operation reduces the pressure within the bottle 124 to a predefined value. It does this by withdrawing the air through the primary vacuum/pressurization conduit 162, the secondary vacuum/pressurization conduit 172, at least one liquid collection housing 174, the inlet/outlet junction 176, the primary vacuum/pressurization hose 178, a pressure sensor (not shown) and into the pump 170. The preservation button 188 may additionally serve as a lock to prevent dispensing of the liquid by accident.

The system 10 is further provided with a dispensing button 190. In one embodiment, the preservation button 188 serves as a lock to prevent unwanted dispensing. In such mode, the pressure sensor monitors the vacuum pressure within bottles 124 in activated chill chambers 20. Where the sensed pressure has risen to an amount above a predefined level, the reversible pump 170 will automatically activate to maintain the desired sub-atmospheric pressure within the bottle 124.

In the above embodiment, the preservation button 188 must be pressed a second time to “unlock” the vacuum pump from its monitoring and sub-atmospheric pressure maintenance duties as described above. Once “unlocked”, the dispensing capability of the system 10 becomes available by pressing the dispensing button 190. Upon activation of the dispensing button, the reversible pump 170 raises the pressure within the bottle 124 by pumping air into the bottle 124 along the same path as noted above for a vacuum operation, only in reverse. One benefit of the use of the same flow paths is the ability of the pressurizing air to flush any trapped liquid from the liquid collection housing 174 back into the bottle 124 for dispensing. The preservation and dispensing buttons 188 and 190 may also include indicator lights that allow a user to visually determine the status of the system 10 and whether or not a dispensing action may be immediately triggered or whether the preservation button 188 must be depressed to “unlock” the system 10, before a dispensing operation is allowed.

When the pressure rises to a sufficient level within the bottle 124, wine will pass through a filter member 210 (FIG. 5) at an end of the concentric dispensing tube 164. At the remote end of the concentric dispensing tube 164, the liquid being dispensed will pass through an outlet junction 192 which is located on the dispensing head 166 of the cartridge 122. In order to maintain the pressure within the bottle 124 during a preservation operation, as well as to prevent the unintended dispensation of the bottled liquid, check valve 168 is placed in the flow path and is spring-biased against the dispensation of the liquid. A super-atmospheric pressure within the bottle 124 sufficient to drive the liquid up the concentric dispensing tube 164 is also sufficient to overcome the force of the spring 186 and open the check valve 168 an amount that will allow the passage of the liquid. In order to reduce or eliminate splashing of the dispensed liquid, prior to exiting the dispensing head 166, the liquid may be passed through a screen 198 of such opacity as to slow the speed of the dispensed liquid. Finally, the dispensed liquid will be directed by a diverter 200 down and away from the dispensing head 166 so as to

be collected into an awaiting vessel. In order to dispense a bottled liquid, the user must maintain the depressed status of the dispensing button 190. Such a safety feature is to avoid overfilling a smaller collection vessel. Finally, to collect any unintended spills, the system 10 may be provided with a drip tray 202 secured to the lower portion of the front or bottom walls 104 or 114 of the outer housing 102 to collect such spills or drips.

Although a detailed description of one preferred embodiment of the present disclosure has been expressed using specific terms and devices, such description is for illustrative purposes only. The words used are words of description rather than of limitation. It is understood that changes and variations may be made by those of ordinary skill in the art without departing from the spirit or scope of the present disclosure, which is set forth in the following claims. Additionally, it should be understood that aspects of various other embodiments may be interchanged either in whole or in part. Therefore, the spirit and scope of the appended claims should not be limited to the detailed description contained herein.

1. A beverage preservation, dispensing and chilling system, comprising:
a housing;
at least one chill chamber recessed in the housing and comprised of right, left, rear, top and bottom upstanding walls, each chill chamber having an associated door positioned on a front wall of the housing;
a first opening in the front wall of the housing associated with and opening into the chill chamber;
a corresponding second opening in the top wall of the chill chamber above the first opening configured to receive a dispensing cartridge; and
a beverage container associated with the dispensing cartridge, the dispensing cartridge being secured to the beverage container prior to the dispensing cartridge and the beverage container being inserted into the chill chamber;
wherein the door is hinged to the front wall of the housing and configured to cover the first opening of the chill chamber after the dispensing cartridge and the beverage container are positioned in the chill chamber.

2. The system of claim 1, further including the at least one chill chamber is a plurality of chill chambers.

3. The system of claim 1, further including a pair of supporting rails on an interior of the housing within the chill chamber onto which the dispensing cartridge is inserted into the chill chamber.

4. The system of claim 3, further including a pair of slides on opposing sides of the dispensing cartridge for cooperative interaction with the pair of supporting rails within the interior of the housing.

5. The system of claim 4, wherein the dispensing cartridge is received into the chill chamber through the second opening.

6. The system of claim 1, the dispensing cartridge further including:
an elbow shaped lever pivotable between an unlocked position where the beverage container may be attached or detached from the dispensing cartridge and a locked position to secure the beverage container to the dispensing cartridge.

7. The system of claim 6, the dispensing cartridge further including:
the elbow shaped lever having one leg that is parallel to the horizontal in one of the locked or unlocked positions.

8. The system of claim 1, further including:
at least one thermoelectric unit, wherein the thermoelectric unit is suited for regulating temperature within the chill chamber;
a container interface assembly associated with the dispensing cartridge; and
a pump in individual fluid communication with the container interface assembly, the pump configured to preserve beverage within the beverage container by generating a sub-atmospheric pressure within the beverage container and to dispense beverage from the beverage container by generating a super-atmospheric pressure within the beverage container.

9. The system of claim 6, further including:
an engagement assembly suited for receipt within a central vertical passage within the dispensing cartridge and suited for supporting the beverage container in a hanging configuration;
the lever suited for generating linear movement of the engagement assembly within the dispensing cartridge's central vertical passage; and
a pair of fluid flow paths, wherein a first fluid flow path is suited for dispensing beverage from the beverage container and a second fluid flow path is suited for pressurization operations within the beverage container.

10. The system of claim 9, wherein only when the lever is pivoted into a locked configuration is the second fluid flow path in fluid communication with the pump for pressurization within the beverage container.

11. A beverage preservation, dispensing and chilling system, comprising:
a housing;
a chill chamber recessed in the housing;
a first opening in a front wall of the housing associated with and opening into the chill chamber;
a corresponding second opening in a top wall of the chill chamber above the first opening, the second opening configured to receive a dispensing cartridge; and
a beverage container associated with the dispensing cartridge, the dispensing cartridge being secured to the beverage container prior to the dispensing cartridge and the beverage container being inserted into the chill chamber;
wherein the beverage container is inserted into the chill chamber through the first opening simultaneously with the cartridge being inserted into the chill chamber through the second opening.

12. A method of preserving, chilling and dispensing a beverage, comprising:
securing a beverage container to a cartridge; and
inserting the beverage container into a chill chamber recessed within a housing through a first opening in a front wall of the housing while simultaneously inserting the secured cartridge into the chill chamber through a second opening formed in a top wall of the chill chamber disposed above the first opening.

13. The method of claim 12, further including:
closing a door positioned on the front wall proximate to the first opening to cover the first opening.

14. The method of claim 13, further including:
energizing a thermoelectric unit configured to regulate the temperature within the chill chamber.

15. The method of claim 13, further including:
energizing a pump in fluid communication with a container interface assembly in fluid communication with the cartridge and the beverage container, the pump configured to preserve beverage within the beverage container by generating a sub-atmospheric pressure within the beverage container and configured to dispense beverage from the beverage container by generating a super-atmospheric pressure within the beverage container.

16. The method of claim 12, wherein the step of securing the beverage container to a cartridge includes the step of pivoting an elbow shaped lever between an unlocked position where the beverage container may be secured to the dispensing cartridge and a locked position to secure the beverage container to the dispensing cartridge.

17. The method of claim 12, further including the step of detaching the beverage container from the cartridge which includes the step of pivoting an elbow shaped lever between a locked position where the beverage container is secured to the dispensing cartridge and an unlocked position where the beverage container may be detached from the dispensing cartridge.
